(19) United States
(12) Patent Application Publication
(10) Pub. No.: US 2003/0163575 A1
(43) Pub. Date: Aug. 28, 2003

(54) Resource location and access

(76) Inventors: Gregory Eugene Perkins, Boise, ID (US); Patrick O?apos;Neil Sandfort, Meridian, ID (US); Shell Sterling Simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/085,927

(22) Filed: Feb. 27, 2002

(51) Int. Cl. G06F 15/16

(52) U.S. Cl. 709/229

(57) ABSTRACT

A method and system enabling programming running on one device to locate and access a resource located and/or operating on another device requiring minimal user interaction and without requiring user's browser to be extended. A method embodying the invention includes providing an interface having instructions to send association data. That association data is then used to identify an identity service responsible for managing resource data. The resource data is then used to locate the resource.

### FIELD OF THE INVENTION

The present invention is directed to a method and system for locating network resources. BACKGROUND OF THE INVENTION

In a basic desktop computing environment, a computer, accessing data from its hard drive, performs a specified function such as word processing, displaying information on a screen, and when requested, producing a document on a connected printer. In a distributed computing environment, the functionality found in the desktop environment is spread across any number of interconnected devices.

For example, a client, in this case a web browser, registers with and stores documents with a document management service. Typically, the management service requires a user to present credentials such as a user name and a password to retrieve or access stored documents. Later, the client accesses a document production service to print a document stored with the document management service. The production service accesses the management service, retrieves a selected document, and prints the document as instructed.

The document production and management services are in many cases independent of one another. In other words, without being informed, one service does not know of the other. The production service does not know which management service the user has registered. Moreover, the production service does not have the credentials to access the user's documents. The production service, without help, cannot locate or access the user's documents. One solution has been to extend the browser to include programming that provides the needed information to the production service. However, extending a browser poses some significant hurdles. For example, the user must download and install the programming, and different programming is required for different browser types and versions.

### SUMMARY OF THE INVENTION

Accordingly, the present invention is directed to a method and system enabling programming running on one device to locate and access a resource located and/or operating on another device requiring minimal user interaction and without requiring the user's browser to be extended. A method embodying the invention includes providing an interface having instructions to send association data. That association data is then used to identify an identity service responsible for managing resource data. The resource data is then used to locate the resource.

A more specific embodiment of the invention can be utilized to produce electronic documents. Upon request from a user, a web page is generated. The web page contains content for requesting a web bug from an association service as well as for displaying controls for selecting production options. After the web page is opened by a browser, the association service is queried to identify an identity service with which the user is registered. The user's resource data is acquired from the identified identity service. Using the resource data, a document management service is located and accessed. Additional content for displaying controls for selecting a document managed by the document management service is provided for the web page interface. Finally a document is produced according to selections made through the web page.

### DESCRIPTION OF THE DRAWINGS

FIG. 1 is a schematic representation of a computer network in which various embodiments of the present invention may be incorporated.

FIG. 2 is a block diagram of the network of FIG. 1 illustrating the logical program components operating on each device according to one embodiment of the present invention.

FIG. 3 is a block diagram logically illustrating an association table according to one embodiment of the present invention.

FIG. 4 is a block diagram logically illustrating an identity table according to one embodiment of the present invention.

FIG. 5 is a flow diagram illustrating resource location and access according to one embodiment of the present invention.

FIG. 6 is a flow diagram illustrating a specific instance of resource location and access according to one embodiment of the present invention.

FIG. 7 is an exemplary screen view of an interface provided in accordance with the flow diagram of FIG. 6.

### DETAILED DESCRIPTION OF THE INVENTION

### GLOSSARY

Program:

An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client-Server:

A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning requested information, if any, back to the client. This requested information may be an electronic file such as a word processing document or spread sheet, a web page, or any other electronic data to be displayed or used by the client. In any given network there may be multiple clients and multiple servers. A single device may contain programming allowing it to operate both as a client device and as a server device. Moreover, a client and a server may both operate on the same device.

Web Server:

A server that implements HTTP (Hypertext Transport Protocol). A web server can host a web site or a web service. A web site provides a user interface by supplying web pages to a requesting client, in this case a web browser. Web pages can be delivered in a number of formats including, but not limited to, HTML (Hyper-Text Markup Language) and XML (extensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface which may be exposed using a variety of protocols layered on top of HTTP, such as SOAP (Simple Object Access Protocol).

Interface:

The junction between a user and a computer program providing commands or menus through which a user communicates with the program. The term user in this context represents generally any individual or mechanism desiring to communicate with the program. A user in many cases is another program. For example, in the client-server model defined above, the server usually generates and delivers to a client an interface for communicating with a program operating on or controlled by the server device. Where the server is a web server, the interface can be a web page from a web site or a programmatic interface from a web service. A web page when displayed by the client device presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands. Where the user is another program, the interface is commonly referred to as a programmatic interface and the controls are logical program elements enabling the user program to provide direction or information.

Session:

An instance of the operation of a program under the control of a particular user. For example, a program or application served over the Internet may be accessed by more than one user at one time. Each instance of a user accessing the program is a session. A session interface then is an interface for interacting with a particular program session.

### INTRODUCTION

In distributed computing environments, a user employs a client to access and direct a server to perform a specified task. The server locates and accesses a network resource to fulfill the request. For example, a user browses to a document production service. The service locates and accesses the user's document repository—a network resource—enabling the user to select a document to be produced. It is expected that various embodiments of the present invention will enable the servers to locate and access network resources with minimal user interaction.

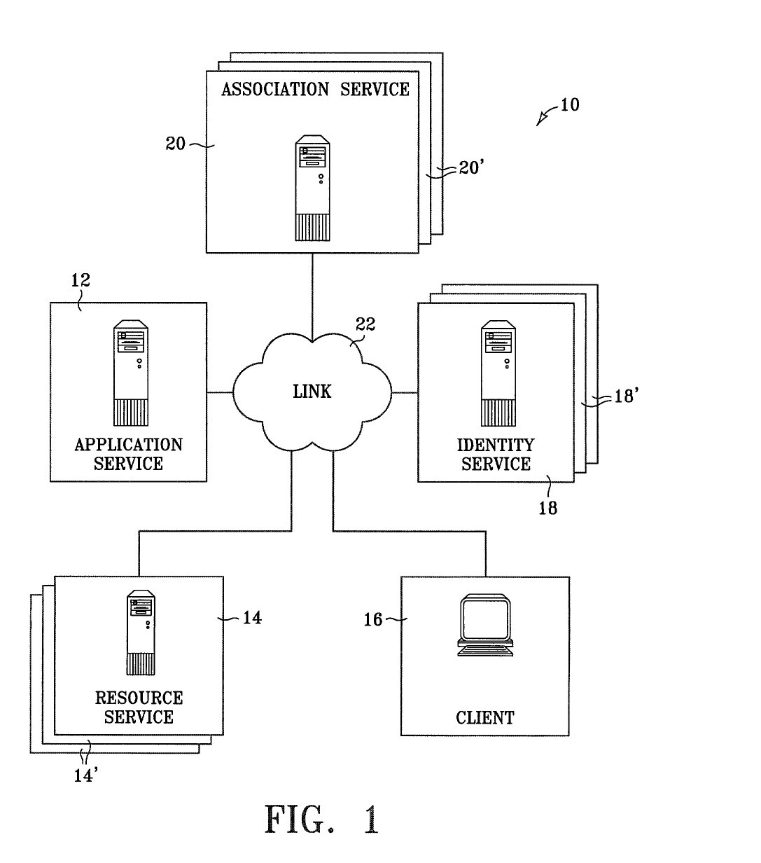

Although the various embodiments of the invention disclosed herein will be described with reference to the computer network environment 10 shown schematically in FIG. 1, the invention is not limited to use with environment 10. The invention may be implemented in or used with any computer system in which it is necessary or desirable to access electronic data. The following description and the drawings illustrate only a few exemplary embodiments of the invention. Other embodiments, forms, and details may be made without departing from the spirit and scope of the invention, which is expressed in the claims that follow this description.

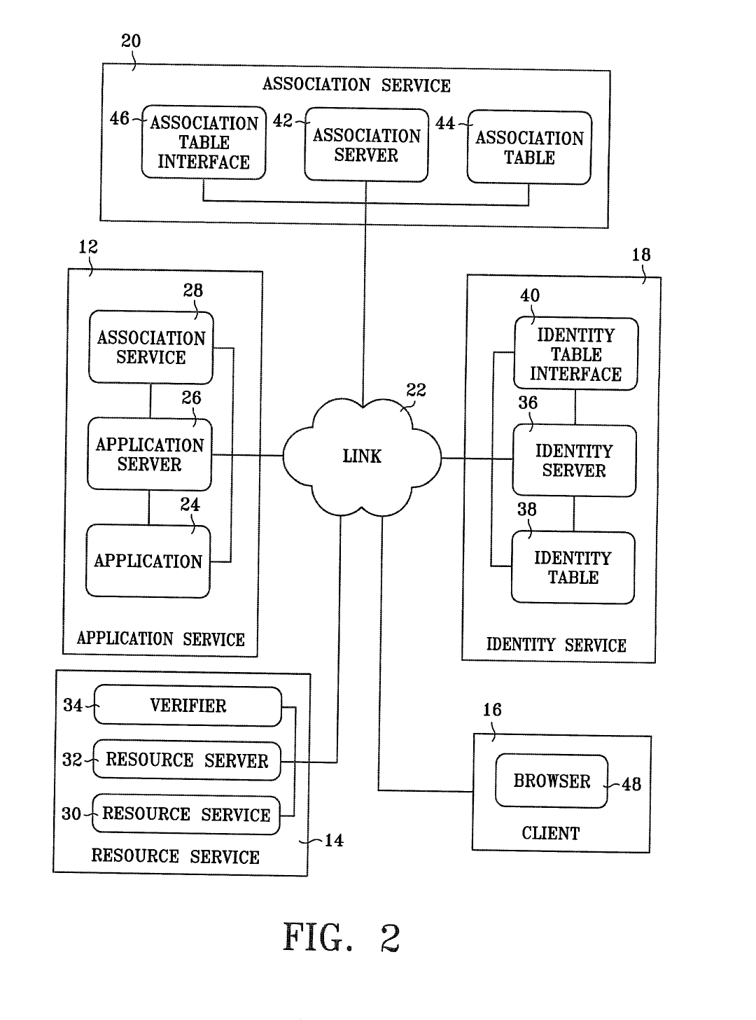

Referring to FIG. 1, computer network environment 10 represents generally any local or wide area network in which a variety of different electronic devices are linked. Enviroment 10 includes application service 12, resource service 14, client 16, identity service 18, and association service 20 all interconnected by link 22. Application service 12 represents generally any combination of programming and/or hardware capable of distributing an application over environment 10. Resource service 14 represents any combination of hardware and/or programming capable of providing a resource to a distributed application. Client 16 represents any combination of hardware and/or programming capable of interacting with application service 12. Identity service 18 represents any combination of hardware and/or programming capable of providing information for locating and accessing resource service 14. Association service 20 represents any combination of hardware and/or programming capable of providing information for locating identity service 18. As FIG. 2 illustrates, environment 10 may include one or more additional resource services 14′, identity services 18′ and association services 20′.

Link 22 interconnects devices 12-20 and represents generally a cable, wireless, or remote connection via a telecommunication link, an infrared link, a radio frequency link, or any other connector or system that provides electronic communication between devices 12-20. Link 22 may represent an intranet, an Internet, or a combination of both. Devices 12-20 can be connected to the environment 10 at any point and the appropriate communication path established logically between the devices.

### COMPONENTS

The logical components of one embodiment of the server association system will now be described with reference to the block diagram of FIG. 2. Application service 12 includes application 24, application server, 26, and association module 28. Application 24 represents generally any application capable of being distributed over environment 10. Application 24 is also capable of generating or otherwise providing an application interface to be displayed by client 16 enabling a user to interact with application 24. Application server 26 represents generally any programming capable of distributing application 24. Association module 28 represents generally any programming capable of querying association service 20.

Resource service 14 includes resource 30, resource server 32, and verifier 34. Resource 30 represents generally any programming capable of being accessed over distributed environment 10. Resource server 32 represents any programming capable of making resource 30 available over environment 10. Verifier 34 represents any programming capable of limiting access to resource 30 to those providing verifiable credentials.

Identity service 18 includes identity server 36, identity table 38, and identity table interface 40. Identity server 36 represents any programming capable of receiving and responding to requests—made by application service 12—for the network address and credentials needed to locate and access resource service 14. Client 16 may access identity service 36 as well to provide needed information. Identity server 36 is also responsible for managing identity table 38. Identity table 38 represents a logical memory area accessible by identity table interface 40 and used to contain identity data. Identity data is data used to locate and access a particular resource 30. Identity data will include the network address or URL for the resource 30 or—more generally—any means by which the network address or URL for resource 30 can be obtained. Identity data also includes credentials for accessing the resource 30. Credential may include a user name and password pair, an encryption/decryption key, and/or any other data used to access secure information. Resource data may be a unique URL such as https://www.documentservice.com/default?creden-tials=user:pass. The portion “https://www.documentservice.com” can be used to locate a particular resource 30. The portion “credentials=user:pass” provides credentials needed to access that resource 30. Identity table interface 40 represents programming capable of providing association module 28 access to identity table 38.

Association service 20 includes association server 42, association table 44, and association table interface 46. Association server 42 represents generally any programming capable of receiving and responding to requests made by association module 28 as well as client 16. Association server 42 is also responsible for managing association table 44. Association table 44 represents a logical memory area accessible by association table interface 46 and used to contain association data. Association data is data associating a user with a session. In this case one session is established when a user makes a request of identity server 36. A second session is established when the user makes a request of application server 26. Association table interface 46 represents programming capable of providing association module 28 with access to association table 44.

It is expected that servers 26, 32, 36, and 42 will be web servers. Application 24 and resource 30 may be web sites, web services, or a combination of the two. Client 16, then, contains browser 48 capable of communicating with servers 26, 32, 36, and 42. Alternatively, in some instances, servers 26, 32, 36, and 42 may be accessed or communicated with programmatically—not using browser 48.

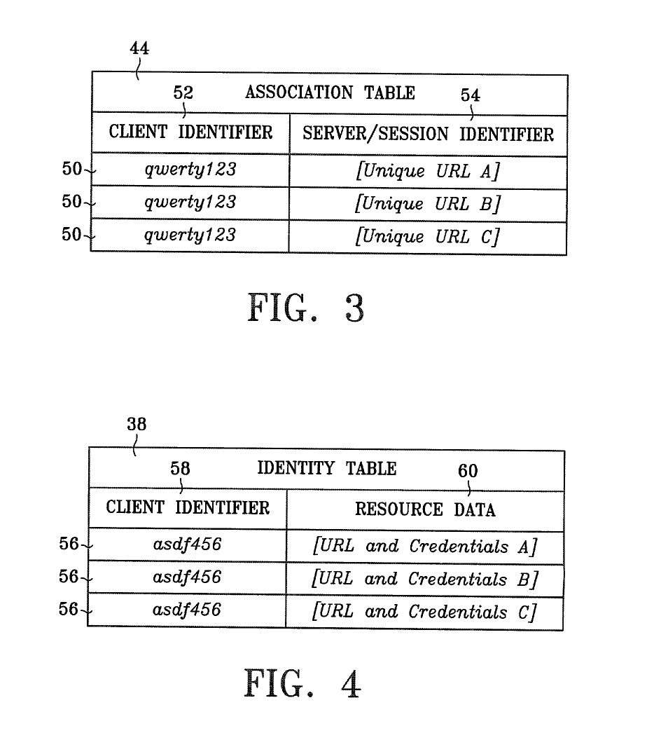

FIG. 3 illustrates the logical elements of association table 44. The exemplary table in FIG. 3 contains three entries 50. Each entry 50 is made up of two fields, a client identifier field 52, and a session identifier field 54. Each time any client 16 accesses association server 42, server 42 adds an entry to association table 44. In the client identifier field 52 it stores data (client identifier) identifying the client 16 or user accessing association server 42. In the server/session identifier field 54, it stores data (session identifier) identifying a server, 26, 32, or 36 for example, of which the identified client or user just made a request as well as data identifying the particular session associated with that request. Where servers 26, 32, 36, and 42 are web servers, a session identifier may be a unique URL (Uniform Resource Locators) identifying a web page in response to a request from browser 48. The following is an example of a unique URL: http://www.printservice.com/default?session=123asd. The portion “www.printservice.com” allows browser 48 to access, for example, identity server 36. The portion “session=123asd” identifies the particular session or instance of the user accessing identity server 36.

A client identifier then may be a cookie. A cookie is a message given to a browser by a web server. The browser stores the message in a text file. The message, in many cases, is a simple alphanumeric data string unique to the given browser. The message is then sent back to the server each time the browser sends a request to the web server. Using the cookie, the web server can distinguish the browser from all other browsers making requests of the web server.

FIG. 4 illustrates the logical elements of identity table 38. The exemplary table in FIG. 4 contains three entries 56. Each entry 56 is made up of two fields, a client identifier field 58, and a resource data field 60. When a user registers with identity service 18, identity server 36 adds an entry to identity table 38. In the client identifier field 58 it stores data (client identifier) identifying the client 16 or user who registered with the identity service 18. In the resource data field 60, it stores resource data used to locate and access one or more resources. Resource data may include the network address and a description of each resource. It may also include any credentials such as a user name and password needed to access the resource. Again, where servers 26, 32, 36, and 42 are web servers, a client identifier may be a cookie, and resource data may include an URL for accessing each resource.

The diagrams of FIGS. 2-4 show the architecture, functionality, and operation of one implementation of the present invention. If embodied in software, each block of FIG. 2 may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programs and data for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, or a portable compact disc.

### OPERATION

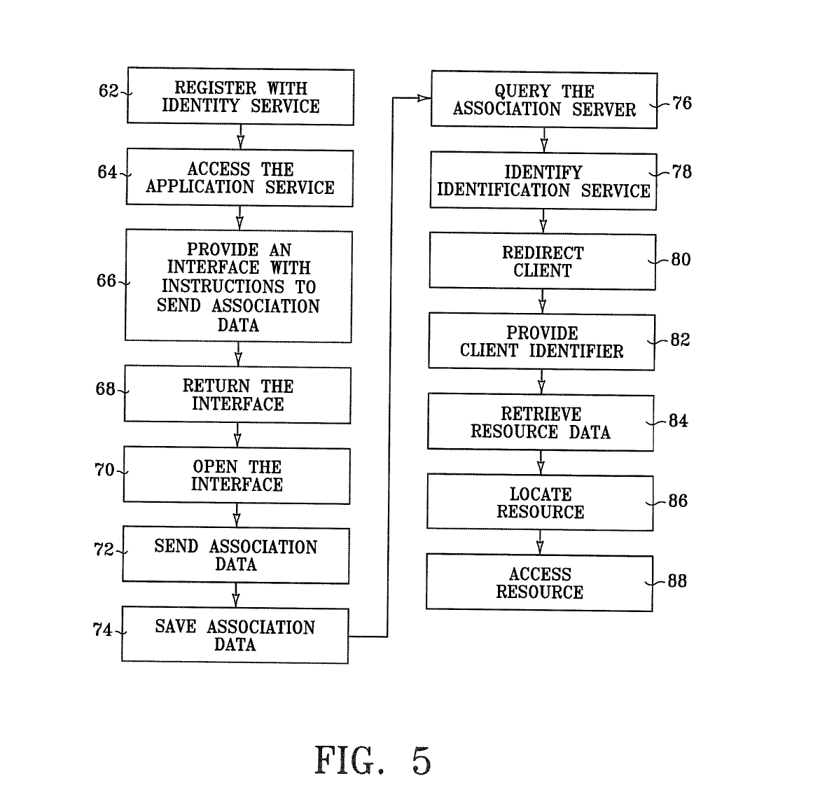

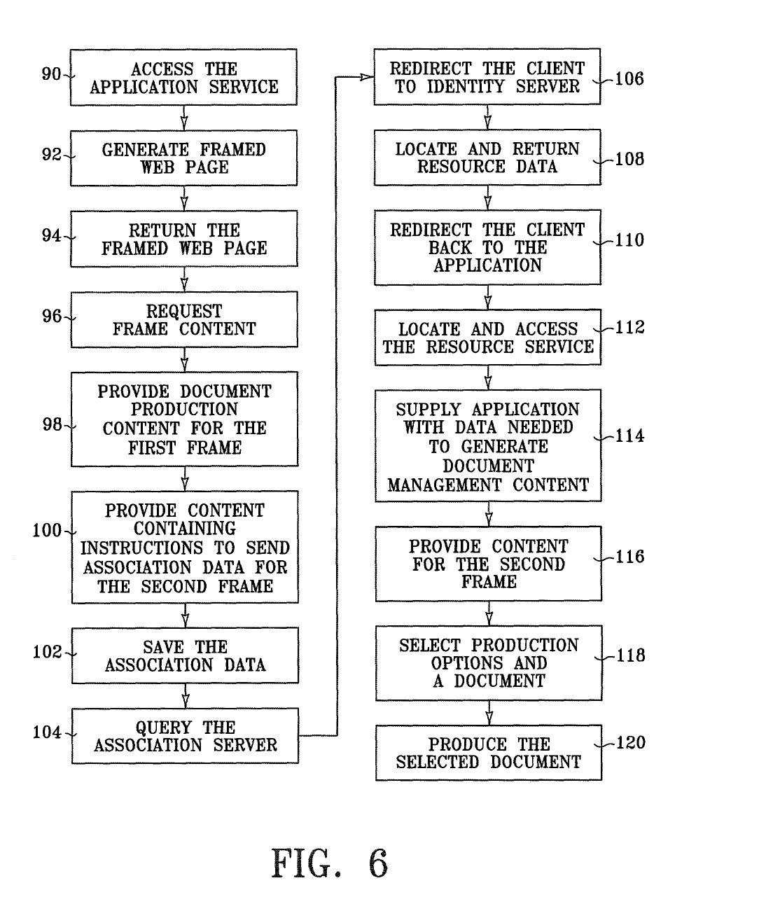

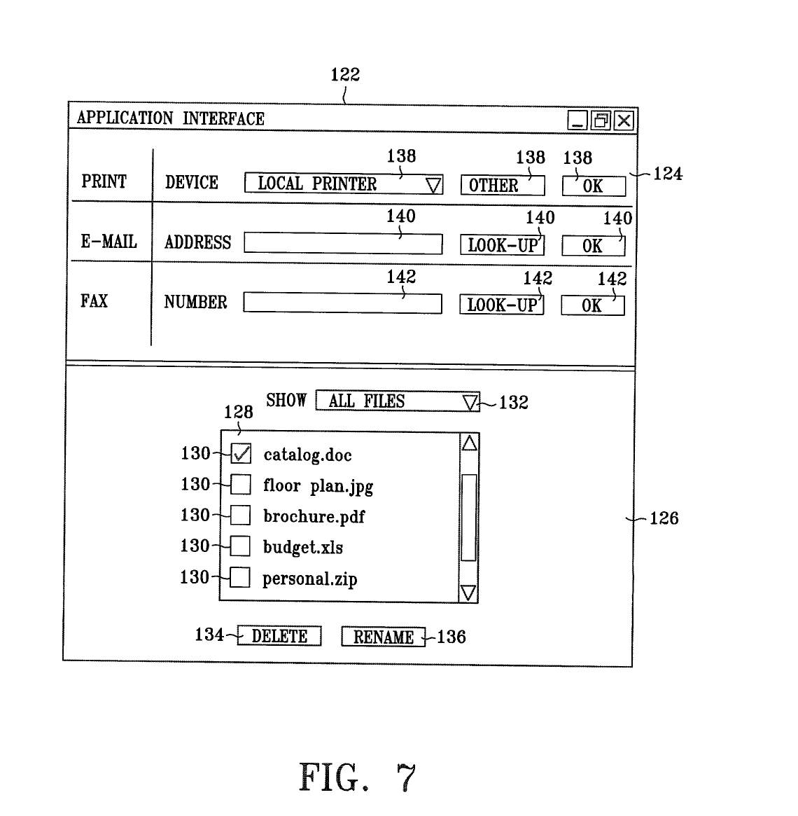

The operation of the invented data access method will now be described with reference to the flow diagrams of FIG. 5 and 6 and the exemplary screen view of FIG. 7. FIG. 5 illustrates, generally, steps taken to locate and access a resource. FIG. 6 provides a more specific example, while FIG. 7 illustrates an exemplary screen of an interface provided by application service 12 in relation to FIG. 6.

Beginning with FIG. 5, using client 16, a user registers with identification service 18 (step 62). To do so, it is expected that the user will, using browser 48, browse to the network address assigned to identity server 36. Identity server 36 returns an identity interface having controls for providing resource data as well as instructions to send association data to association service 20. It is expected that the identity interface will be a dynamically generated web page having a unique URL. Identity server 36 returns the identity interface to client 16.

Client 16 opens the identity interface and accesses association service 20 sending association data. Where the identity interface is a web page, the instructions to send association data may be instructions to request a web bug from association server 42. A web bug is typically a small image, one pixel in size and is invisible to the user. The image itself usually does not serve a function. However, the request for the image does. When requesting the image, browser 48 sends a client identifier in the form of a cookie and the session identifier in the form of the URL of the identity interface web page to association server 42. If client 16 does not have a cookie for the association server 42, association server 42 generates one and saves it on client 16. Upon receipt of the association data, association server 42 saves the cookie and the URL as an entry 50 in association table 44. At this point the user has established a relationship with association service 20. The relationship is reflected by entry 50 as well as the cookie for association server 42 saved on client 16.

When client 16 accesses identity service 18, identity server 36 generates a client identifier and saves that identifier on client 16. Where identity server 36 is a web server, it is expected that this client identifier will be a cookie for identity server 36. After displaying the identity interface, client 16 returns resource data entered through the identity interface back to identity server 36 which saves the generated client identifier and the resource data as an entry 56 in identity table 38. Each time client 16 requests access to identity service 18, identity server 36 can retrieve from client 16 the client identifier for identity server 36 and instruct identity table interface 40 to locate an entry or entries in identity table 38 containing that client identifier.

Next, a user requests accesses to application service 12 (step 64). To do so, it is expected that the user will, using browser 48, browse to the network address assigned to application server 26. Application server 26 receives and communicates the request to application 24, which then provides an application interface that includes instructions to send association data to association service 20 (step 66). Because application service 12 does not know which association service 20 or 20′ with which the user has established a relationship, application interface may also include instructions to send association data to association service(s) 20′. It is expected that the interface will be a dynamically generated web page having a unique URL. Application server 26 returns the application interface to client 16 (step 68).

Client 16 opens the application interface (step 70) and accesses association service 20 sending association data to association services 20 and 20′ (step 72). Where the application interface is a web page, the instructions to send association data may be instructions to request a web bugs from association services 20 and 20′. When requesting the web bugs, browser 48 sends a client identifier in the form of a cookie and the session identifier in the form of the URL of the application interface web page provided in step 66 to each association service 20 and 20′. The cookies sent are unique to each association service 20 and 20′. Upon receipt, association services 20 and 20′ each save the association data, the cookie and the URL, as an entry 50 in association table 44, in the case of association service 20, or in association table(s) 44′ (not shown) in the case of association service(s) 20′ (step 74).

Association module 28 queries each association service 20 and 20′ to identify the session identifier (URL) for the identity service 18 with which the user is registered in step 62 (step 76). Association module 28 provides association services 20 and 20′ with the URL for the application interface provided in step 66. in the case of association service 20, association server 42 passes the information to association table interface 46 which locates the entry 50 in association table 44 containing the provided URL and ascertains the client identifier (cookie) contained in that entry 50. In the case of association service(s) 20′, association table interface(s) 46′ (not shown) locate the entry or entries 50′ (not shown) in association tables 46′ (not shown) containing the provided URL and ascertain the client identifier(s) contained in entry or entries 50′

In the case of association service 20, association table interface 46 then locates each other entry 50 in association table 44 that contains the ascertained client identifier. One of those entries 50 will contain the session identifier (URL) for the identity service 18 with which the user is registered. For each located entry 50, association table interface 46 returns the session identifier to association module 28. Association module 28 identifies the session identifier (URL) for the identity service 18 and communicates that information to application 24 which then associates the session identifier for identity service 18 with that of the application interface provided in step 66 (step 78). Association table interface 46 may provide a way of filtering the session identifiers, so only those session identifiers associated with an identity services will be returned. Additionally, association table interface may filter out extraneous data in the session identifier.

Because the user has not established a relationship with association service(S) 20′, association service(s) 20′ will not have access to data identifying identity service 18. Consequently, association server(s) 20′ need not respond to the query from association module 28 issued in step 76.

Application server 26 then redirects client 16 to identity service 18 using the session identifier ascertained in step 78 (step 80). When redirected, browser 48 requests access to identity service 18 providing the client identifier generated when the user registered with identity service 18 in step 62 (step 82). In response, identity server 36 retrieves the entry or entries 56 from identity table 38 containing the provided client identifier and provides application service 12 with the resource data contained in each (step 84). Alternatively, this data may be filtered to only include the requested data-encoded into the redirection URL—and the user may be made aware of this request (or even be asked to approve it). Application 24 identifies the resource data belonging to resource service 14, locates resource service 14 (step 86) and accesses resource 30 (step 88).

FIGS. 6 and 7 helps illustrate a specific implementation of the present invention in which application 24 provides a document production service and resource 30 provides a document management service. In this example, it is assumed that servers 26, 30, 36, and 42 are web servers. FIG. 6 is a flow chart illustrating steps taken to complete the process while FIG. 7 is an exemplary screen view of an application interface provided by application 24.

Beginning with FIG. 6, using browser 48, a user requests access to application service 12, in this case a document production service, browsing to the network address for application server 26 (step 90). Application server 26 communicates the request to application 24, which generates a framed web page (step 92). A framed web page is one that divides the browser's display area into two or more sections or frames. The actual content of each frame is not provided by the framed web page itself. Rather, the framed web page provides, for each frame, a network address for accessing content to be displayed in that frame. Consequently, when browser 48 requests access to application server 26, application 24 provides a framed web page that includes a network address for retrieving document production content for the first frame and document selection and management content for the second frame. In this example, the content for the first frame is provided by application 24. The content for the second frame is also provided by application 24 but only after application 24 locates and accesses the document management service, that is, resource service 14. The document or documents to be printed may be stored anywhere that is accessible by resource 30.

Application server 26 returns the framed web page to browser 48 to be displayed on client 16 (step 94). When displayed, browser 48 requests the content for the frames using the network addresses provided in the framed web page (step 96). In this example, the requests are directed to application server 26. Application server 26 communicates the requests to application 24. For the first frame, application 24 provides content for selecting production options (step 98). For the second frame application 24 provides a web page having a unique URL that includes instructions to send association data, a cookie for association server 42 and the URL for the content of the second frame, to association service 20 (step 100). Upon receipt, association server 42 saves the association data as an entry 50 in association table 44 (step 102).

Providing the URL for the web page displayed in the second frame, association module 28 then queries association server 42 for the URL for identity service 18 with which the user is registered (step 104). Association server 42 passes the provided URL to association table interface 46 which locates the entry 50 in association table 44 containing the provided URL and ascertains the cookie contained in that entry 50. Association table interface 46 then locates each other entry 50 in association table 44 that contains the ascertained cookie. One of those entries 50 will contain the URL for identity service 18. Association table interface 46 may have intrinsic knowledge that URLs with certain domain names are identity services. Furthermore, association table interface 46 may provide a means for filtering on identity services. For each located entry 50 containing an URL for an identity service, association table interface 46 returns the entry's URL, or perhaps the domain name of the identified identity service 18, to association module 28. From the data returned, association module 28 identifies the particular URL or domain name for identity server 36.

Using the URL or domain name identified by association module 28, application 24 redirects the second frame to identity server 36 (step 106). This can be accomplished, for example, by providing content for the second frame web containing logic to redirect the second frame back to application server 26 after a set period of time. The web application server 26 responds to the request resulting from this redirection with another redirection to identity server 36. Requesting access to identity server 36, browser 48 provides identity server 36 with the cookie saved when the user registered with identity service 18 as well as the URL (referring URL) for the content provided by application 24 for the second referring frame (the second frame). Identity server 36 forwards the cookie to identity table interface 40 which locates all entries 56 in identity table 38 that contain that particular cookie. Identity table interface 40 then returns the resource data pertaining to resource service 14 to application 24 using the referring URL (step 108), and redirects the second frame back to application service 12, again, using the referring URL (step 110).

Utilizing the returned resource data, application 24 locates and accesses resource service 14 (step 112). It is expected that the resource data will include an URL needed to access resource server 32 as well as credentials—or a means of directly or indirectly obtaining the credentials—needed to access resource 30. Application 24 uses the URL to access resource server 32 and then provides the credentials. Verifier 34 authenticates the credentials, and if valid, enables access to resource 30. Resource 30, a document management service, then supplies application 24 with data needed to generate content for the second frame (step 114). Using the supplied data, application 24 provides, for the second frame, content for selecting the user's documents managed by resource service 14 (step 116). The user, through browser 48, selects production options and a document to be produced (step 118). Application 24 acquires the selected document and produces it accordingly (step 120).

FIG. 7 is an exemplary screen view of an interface 122 displaying content for selecting and producing an electronic document. In first frame 124, application 24 provides the content for entering production selections. In second frame 126, application 24 provides content for selecting a user's documents managed by resource service 14.

The content provided for second frame 126 includes a scroll menu 128 displaying electronic documents accessible by resource 30. In this example scroll menu 128 includes check boxes 130 allowing the user to select one or more of the displayed documents. Here, the document “catalog.doc” has been selected. Also included is pull down menu 132 and command buttons 134 and 136. Pull down menu 132 allows a user to select the type of documents displayed in scroll menu 128. In this example “all documents” is selected. A user may, however, desire to show only word processor documents or spreadsheets. Command buttons 134 and 136 allow a user to perform tasks such as deleting or renaming documents selected in scroll menu 128.

The content provided for first frame 124 includes controls 138-142 for printing, e-mailing, faxing, and archiving a document selected in second fame 126. Using controls 138, a user can instruct application 24 to print a document or documents selected in second frame 126. Using controls 140 or 142, the user can instruct application 24 to send the selected document to a particular e-mail address or fax the document to a particular number.

Although the flow charts of FIGS. 5 and 6 show a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention. The screen display of FIG. 7 is exemplary only. There exist many possible layout and control configurations for interfaces that will allow a user to select and produce an electronic document. FIG. 7 merely provides one such example.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. In a computer network, a method for locating a resource, comprising:
providing an interface having instructions to send association data;
identifying an identity service using the association data, the identity service managing resource data; and
locating the resource using the resource data.

2. The method of claim 1, further comprising performing a specified task utilizing the resource.

3. The method of claim 1, wherein the association data includes a client identifier and a session identifier associated with the interface, and wherein the act of identifying comprises:
providing the session identifier associated with the interface, identifying the client identifier included in the association data;
identifying other association data containing that client identifier; and
acquiring at least a portion of the session identifier included in the other association data.

4. The method of claim 1, wherein the act of providing comprises providing a web page having instructions to request a web bug sending association data containing a cookie and an URL for the web page; and
wherein the act of identifying comprises:
providing the URL to identify the association data containing the cookie;
identifying other association data containing the cookie; and
acquiring an URL for the identity service from the identified association data.

5. In a computer network, a method for locating a resource for a user, comprising:
providing an interface having instructions to send association data to two or more association services;
identifying from the two or more association services, an association service with which the user has established a relationship;
identifying an identity service using the association data sent to the identified association service, the identity service managing resource data; and
locating the resource using the resource data.

6. In a computer network, a method for locating a resource comprising:
providing a web page having instructions to request a web bug;
requesting the web bug sending a cookie and an URL for the web page;
saving the cookie and the URL for the web page as an entry in an association table;
querying, providing the URL for the web page, the association table for the cookie in the entry containing the URL;
identifying other entries in the association table containing the cookie;
identifying from those entries an entry containing an URL for an identification service, the identification service managing resource data; and
locating the resource using the resource data.

7. A method for producing an electronic document, comprising:
generating, upon request from a user, a web page having content for requesting a web bug from an association service as well as content for displaying controls for selecting production options;
querying the association service to identify an identity service with which the user is registered providing an URL for the generated web page;
obtaining the user's resource data from the identified identity service;
locating and accessing a document management service using the resource data;
providing additional content for the web page for displaying controls for selecting a document managed by the document management service; and
producing a document according to selections made through the web page.

8. The method of claim 7, wherein:
the act of generating comprises generating a web page having instructions to request a web bug sending, to the association service association, data containing a cookie and an URL for the web page;
the method further comprises saving the association data as an entry in an association table;
the act of querying further comprises identifying the cookie in the saved entry using the provided the URL, identifying other association data containing the identified cookie, and, from the other identified association data, acquiring an URL for the identity service; and
the act of obtaining the user's resource data comprises obtaining the user's resource data from the identified identity service using, at least in part, the acquired URL.

9. A computer readable medium having instructions for:
providing an interface having instructions to send association data;
identifying an identity service using the association data, the identity service managing resource data; and
locating a resource using the resource data.

10. The medium of claim 9, having further instructions for performing a specified task utilizing the resource.

11. The medium of claim 9, wherein the association data includes a client identifier and a session identifier associated with the interface, and wherein the instructions for identifying comprise instructions for:
providing the session identifier associated with the interface, identifying the client identifier included in the association data;
identifying other association data containing that client identifier; and
acquiring the session identifier included in the other association data.

12. The medium of claim 9, wherein the instructions for providing comprise instructions for providing a web page having instructions to request a web bug sending association data containing a cookie and an URL for the web page; and wherein the instructions for identifying comprise instructions for:
providing the URL to identify the association data containing the cookie;
identifying other association data containing the cookie; and
acquiring, from the identified association data, an URL for the identity service.

13. A computer readable medium having instructions for:
providing an interface having instructions to send association data to two or more association services;
identifying from the two or more association services, an association service with which a user has established a relationship;
identifying an identity service using the association data sent to the identified association service, the identity service managing resource data; and
locating a resource for the user using the resource data.

14. A computer readable medium having instructions for:
providing a web page having instructions to request a web bug;
requesting the web bug sending a cookie and an URL for the web page;
saving the cookie and the URL for the web page as an entry in an association table;
querying, providing the URL for the web page, the association table for the cookie in the entry containing the URL;
identifying another entries in the association table containing the cookie;
identifying, from those entries, the entry containing an URL for an identification service, the identification service managing resource data; and
locating a resource using the resource data.

15. A computer readable medium having instructions for:
generating, upon request from a user, a web page having content for requesting a web bug from an association service as well as content for displaying controls for selecting production options;
querying the association service to identify an identity service with which the user is registered providing an URL for the generated web page;
obtaining the user's resource data from the identified identity service;
locating and accessing a document management service using the resource data;
providing additional content for the web page for displaying controls for selecting a document managed by the document management service; and
producing a document according to selections made through the web page.

16. The medium of claim 15, wherein:
the instructions for generating comprise instructions for generating a web page having instructions to request a web bug sending to the association service association data containing a cookie and an URL for the web page;
the medium having further instructions for saving the association data as an entry in an association table;
the instructions for querying further comprise instructions for identifying the cookie in the saved entry using the provided the URL, identifying other association data containing the identified cookie, and, from the other identified association data, acquiring an URL for the identity service; and
the instructions for obtaining the user's resource data comprise instructions for obtaining the user's resource data from the identified identity service using, at least in part, the acquired URL.

17. A system for locating a resource, comprising:
an association module operable to query an association service, supplying a session identifier, in order to identify an identity service managing resource data; and
an application operable to:
provide an interface having instructions to send association data to the association service, the association data to contain a client identifier and a session identifier for the provided interface;
acquire resource data from an identity service identified by a query from the association module; and
locate the resource using the resource data.

18. The system of claim 17, wherein:
the application is further operable to provide the interface in the form of a web page having instructions to send association data containing a cookie and the URL for the provided web page; and
the association module is further operable to provide the URL and query the association service for an URL for the identity service.

19. A document production system, comprising:
an association module operable to query an association service, supplying a session identifier in order to identify an identity service managing resource data; and
a document production application operable to:
provide an interface having content for sending association data containing a session identifier for the provided interface to an association service as well as content for displaying controls for selecting production options;
acquire resource data from an identity service identifier identified by a query from the association module;
locate and access a document management service using the resource data; and
provide, for the interface, additional content for displaying controls for selecting a document managed by the document management service; and
produce a document according to selections made through the interface.

20. A system for locating a resource, comprising:
an identity service operable to manage resource data;
an association server operable to receive association data containing a client identifier and a session identifier, save the association data in an association table, and receive queries for the association table;
an association table interface in communication with the association server and operable, according to a received query, to access from the association table a session identifier for the identity service using a session identifier supplied with the query;
an association module operable to query, supplying a session identifier, the association service in order to identify the identity service;
an application operable to:
provide an interface having instructions to send association data to an association server, the association data to contain a client identifier and a session identifier for the provided interface;
acquire resource data from the identity service identified by a query from the association module; and
locate the resource using the resource data.

21. The system of claim 20, wherein:
the application is further operable to provide the interface in the form of a web page having instructions to send association data containing a cookie and the URL for the provided web page;
the association module is further operable to provide the URL interface and query the association service for an URL for the identity service; and
the association table interface is further operable to locate an entry in the association table containing the provided URL, identify the cookie in the located entry, identify other entries containing that cookie, and, from those other entries, acquire an URL for the identity service; and
the application is further operable to use the acquired URL to acquire resource data from the identity service.

22. A document production system, comprising:
a document management service;
an identity service operable to manage resource data for locating and accessing the document management service;
an association server operable to receive association data containing a client identifier and a session identifier, save the association data in an association table, and receive queries for the association table;
an association table interface in communication with the association server and operable, according to a received query, to access from the association table a session identifier for the identity service using the session identifier supplied with the query;
an association module operable to query, supplying a session identifier, the association service in order to identify the identity service;
a document production application operable to:
provide an interface having content for sending association data containing a client identifier and a session identifier for the provided interface to an association service as well as content for displaying controls for selecting production options;
acquire resource data from an identity service using the session identifier for the identity service identified by a query from the association module;
locate and access the document management service using the resource data;
provide, for the interface, additional content for displaying controls for selecting a document managed by the document management service; and
produce a document according to selections made through the interface.

23. The system of claim 22, wherein:
the association table interface is further operable to locate an entry in the association table containing the session identifier supplied with a query, identify the client identifier in the located entry, identify other entries containing that client identifier, and, from those other entries, acquire a session identifier for the Identity service; and
the document production application is further operable to use the acquired session identifier for the identity service to acquire resource data from the identity service.

24. A system for locating a resource, comprising:
a means for querying, supplying a session identifier, an association service in order to identify an identity service managing resource data;
a means for providing an interface having instructions to send association data to the association service, the association data to contain a client identifier and a session identifier for the provided interface;
a means for acquiring resource data from an identity service identified by a query; and
a means for locating the resource using the resource data.

25. A document production system, comprising:
a means for querying, supplying a session identifier, an association service in order to identify an identity service managing resource data;
a means for providing an interface having content for sending association data containing a session identifier for the provided interface to the association service as well as content for displaying controls for selecting production options;
a means for acquiring resource data from an identity service identifier identified by a query;
a means for locating and accessing a document management service using the resource data;
a means for providing, for the interface, additional content for displaying controls for selecting a document managed by the document management service; and
a means for producing a document according to selections made through the interface.
